(19) United States
(12) Patent Application Publication
(10) Pub. No.: US 2021/0122664 A1
(43) Pub. Date: Apr. 29, 2021

(54) METHOD FOR MANUFACTURING GLASS PREFORM

(71) Applicant: SUMITOMO ELECTRIC INDUSTRIES, LTD., Osaka-shi, Osaka (JP)

(72) Inventors: Masatoshi HAYAKAWA, Osaka-shi, Osaka (JP); Masumi ITO, Osaka-shi, Osaka (JP); Tatsuya KONISHI, Osaka-shi, Osaka (JP)

(73) Assignee: SUMITOMO ELECTRIC INDUSTRIES, LTD., Osaka-shi, Osaka (JP)

(21) Appl. No.: 17/057,134

(22) PCT Filed: May 22, 2019
(86) PCT No.: PCT/JP2019/020238

§ 371 Date: Nov. 20, 2020

(30) Foreign Application Priority Data
May 22, 2018 (JP) 2018-097651

(51) Int. Cl. C03B 37/014

(52) U.S. Cl. CPC C03B 37/0142; C03B 37/018; C03B 37/01446

(57) ABSTRACT

A method for manufacturing a glass preform, the method having: a depositing step for installing a starting rod and a burner for generating glass fine particles in a reaction container, introducing a siloxane as a glass raw material to the burner, oxidizing the glass raw material in a flame formed by the burner and generating glass fine particles, depositing the generated glass fine particles on the starting rod and fabricating a glass fine particle deposited body; and a transparentizing step for heating the glass fine particle deposited body and manufacturing a transparent glass preform, wherein, after the depositing step, the transparentizing step is performed after the glass fine particle deposited body is heated for a time range of one to eight hours in an oxygen-containing atmosphere at a temperature lower than the temperature of the transparentizing step.

### TECHNICAL FIELD

The present disclosure relates to a method for manufacturing a glass preform. This application claims priority based on Japanese Patent Application No. 2018-097651 filed on May 22, 2018, the contents of which are incorporated herein by reference in its entirety.

### BACKGROUND ART

Patent Literature 1 describes a method for manufacturing a glass preform, which includes a transparentizing step of manufacturing a glass fine particle deposit using a siloxane as a raw material for glass synthesis and heating the manufactured glass fine particle deposit to manufacture a transparent glass preform.

### CITATION LIST

### Patent Literature

Patent Literature 1: JP-A-2015-113259

### SUMMARY OF INVENTION

The present disclosure provides a method for manufacturing a glass preform, the method including:
a depositing step of preparing a glass fine particle deposit by installing a starting rod and a burner for producing glass fine particles in a furnace, introducing a siloxane as a glass raw material to the burner, producing the glass fine particles by oxidizing the glass raw material in a flame formed by the burner, and depositing the produced glass fine particles on the starting rod; and
a transparentizing step of manufacturing a transparent glass preform by heating the glass fine particle deposit and,
in which, after the depositing step, the glass fine particle deposit is heated in a range of 1 hour or longer and 8 hours or shorter in an oxygen-containing atmosphere at a temperature lower than a temperature of the transparentizing step (hereinafter, also referred to as “oxidation heating step”), and then, the transparentizing step is performed.

### BRIEF DESCRIPTION OF DRAWINGS

FIG. 1 is a configuration diagram showing an embodiment of an apparatus for performing a depositing step of a method for manufacturing a glass preform according to an embodiment of the present disclosure.

FIG. 2 is a configuration diagram showing an embodiment of an apparatus for performing an oxidation heating step and a transparentizing step of the method for manufacturing a glass preform according to an embodiment of the present disclosure.

### DESCRIPTION OF EMBODIMENTS

### Problems to be Solved by the Present Disclosure

When a glass fine particle deposit is manufactured by using siloxane as a raw material for glass synthesis by the method as described in Patent Literature 1, some of the deposited glass fine particles are sometimes blackened. When manufacturing a transparent glass preform by heating and consolidating the glass fine particle deposit containing the blackened glass fine particles (hereinafter, also referred to as “black glass fine particles”), voids are sometimes generated in the obtained glass preform. Since the presence of the voids in the glass preform manufactured for optical fibers leads into breakage of the wire in a drawing step performed thereafter or formation of a cavity in the optical fiber, the portion in which voids are generated is discarded, which reduces the yield.

Since silicon dioxide (SiO₂) as the main component of the glass fine particles is white, when the SiO₂ has a purity of 100%, the glass fine particles will also be white. Meanwhile, silicon monoxide (SiO) is brown or black, and accordingly, when siloxane is used as the glass raw material, it is assumed that the produced glass fine particles are blackened because of the inclusion of the secondary produced insufficiently oxidized silicon oxide (SiOx, X<2). Therefore, the generation of the voids in the glass preform obtained by heating and consolidating the deposit containing the blackened glass fine particles is considered to be due to the inclusion of the insufficiently oxidized silicon oxide.

Accordingly, an object of the present disclosure is to provide a method for manufacturing a glass preform, which is capable of reducing an amount of voids generated in a glass preform obtained in a later step even when a glass fine particle deposit is manufactured using siloxane as a raw material for glass synthesis.

### Effects of the Present Disclosure

According to the present disclosure, even when a glass fine particle deposit is manufactured using siloxane as a raw material for glass synthesis, it is possible to manufacture a glass preform with a small amount of generated voids.

### Description of Embodiments of the Present Disclosure

First, the contents of the embodiments of the present disclosure will be listed and described.

A method for manufacturing a glass preform according to an embodiment of the present disclosure is

(1) a method for manufacturing a glass preform, the method including:
a depositing step of preparing a glass fine particle deposit by installing a starting rod and a burner for producing glass fine particles in a furnace, introducing a siloxane as a glass raw material to the burner, producing the glass fine particles by oxidizing the glass raw material in a flame formed by the burner, and depositing the produced glass fine particles on the starting rod; and
a transparentizing step of manufacturing a transparent glass preform by heating the glass fine particle deposit,
in which, after the depositing step, the glass fine particle deposit is heated in a range of 1 hour or longer and 8 hours or shorter in an oxygen-containing atmosphere at a temperature lower than a temperature of the transparentizing step, and then, the transparentizing step is performed.

With this configuration, even when the deposit prepared in the depositing step contains black glass fine particles, since insufficiently oxidized silicon oxide (SiOx, X<2), which is assumed to be a main component of the black glass fine particles, can be oxidized by heating in an oxygen atmosphere to form white glass fine particles, the amount of voids generated in the glass preform obtained in the transparentizing step performed thereafter can be reduced.

(2) It is preferable that a heating temperature in an oxygen-containing atmosphere is in a range of 500° C. or higher and 1100° C. or lower.

With this configuration, whitening of the black glass fine particles can be performed within an appropriate time.

(3) It is preferable that an oxygen content in the oxygen-containing atmosphere is 10 vol % or more.

With this configuration, the whitening of the black glass fine particles can be performed with an appropriate heating amount within an appropriate time.

(4) It is preferable that the oxygen content in the oxygen-containing atmosphere is in a range of 20 vol % or more to 100 vol % or less.

With this configuration, the whitening of the black glass fine particles can be performed with a more appropriate heating amount within a more appropriate time.

(5) It is preferable that the oxygen-containing atmosphere is an air atmosphere.

With this configuration, oxygen concentration adjustment equipment, heavy fireproof or explosion proof equipment, and the like are not required, and implementation with simple equipment is possible.

### [Description of Embodiments]

### Overview of Apparatus Used and Others

Hereinafter, an example of a method for manufacturing a glass preform according to an embodiment of the present disclosure will be described with reference to the accompanying drawings.

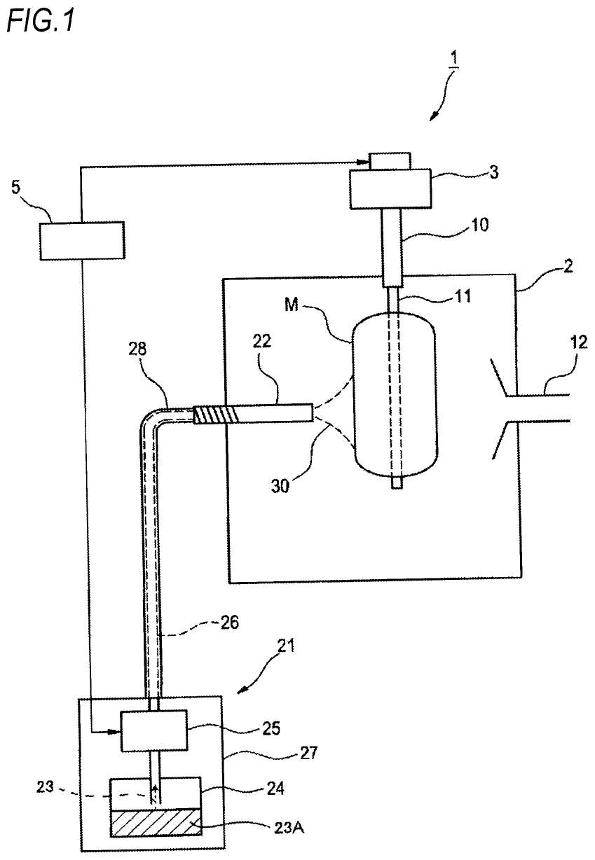

FIG. 1 is a configuration diagram of an apparatus 1 (hereinafter, also referred to as “glass fine particle deposit manufacturing apparatus” or “deposit manufacturing apparatus”) for performing a depositing step, in a method for manufacturing a glass preform of the present embodiment. The deposit manufacturing apparatus 1 includes a furnace 2, a lifting and lowering and rotating device 3, a raw material supply device 21, a burner 22 for producing glass fine particles, and a control unit 5 that controls the operation of each unit.

The furnace 2 is a container by which a glass fine particle deposit M is formed, and includes a discharge pipe 12 attached to a side surface of the container.

The lifting and lowering and rotating device 3 is a device for rotating and also lifting and lowering the glass fine particle deposit M with a support rod 10 and a starting rod 11. The lifting and lowering and rotating device 3 lifts and lowers and also rotates the glass fine particle deposit M based on a control signal transmitted from the control unit 5.

The support rod 10 is disposed by being inserted through a through hole formed in an upper wall of the furnace 2. A starting rod 11 is attached to one end (lower end in FIG. 1) of the support rod 10 disposed in the furnace 2. The other end (upper end in FIG. 1) of the support rod 10 is held by the lifting and lowering and rotating device 3.

The starting rod 11 is a rod on which glass fine particles are deposited, and is attached to the support rod 10.

The discharge pipe 12 is a pipe for discharging the glass fine particles, which are not attached to the starting rod 11 and the glass fine particle deposit M, to the outside of the furnace 2.

A raw material gas 23 vaporized in the raw material supply device 21 is supplied to the burner 22. Here, in FIG. 1, a gas supply device for supplying a flame forming gas is not shown.

The raw material supply device 21 includes a vaporization container 24 that vaporizes a liquid raw material 23A, a Mass Flow Controller (MFC) 25 that controls the gas flow rate of the raw material gas 23, a supply pipe 26 that guides the raw material gas 23 to the burner 22, and a temperature control booth 27 that partially controls the temperature of the vaporization container 24, the MFC 25, and the supply pipe 26. The liquid raw material 23A is siloxane.

The MFC 25 is a device that supplies the raw material gas 23, which is to be emitted from the burner 22, to the burner 22 through the supply pipe 26. The MFC 25 controls a supply amount of the raw material gas 23 to be supplied to the burner 22 based on a control signal transmitted from the control unit 5.

The supply pipe 26 is a pipe that guides the raw material gas 23 to the burner 22. In order to maintain the supply pipe 26 at a high temperature, it is preferable that a tape heater 28, which is a heating element, is wrapped around an outer periphery of the supply pipe 26 and a portion of an outer periphery of the burner 22. The tape heater 28 is energized to heat the supply pipe 26 and the burner 22 so that the temperature of the raw material gas 23 emitted from the burner 22 can be raised to a temperature at which the vaporized raw material gas is not condensed. For example, when the liquid raw material 23A is octamethylcyclotetrasiloxane (OMCTS), the temperature may be raised to a temperature of 175 to 200° C. which is higher than the standard boiling point of 175° C. of OMCTS.

The burner 22 oxidizes the raw material gas 23 in the flame to produce glass fine particles 30, and the produced glass fine particles 30 are sprayed onto the starting rod 11 to be deposited. For the burner 22 for ejecting the glass raw material 23 and the flame forming gas, a cylindrical multi-nozzle structure or a linear multi-nozzle structure is used, for example.

The control unit 5 controls each operation of the lifting and lowering and rotating device 3, the raw material supply device 21, and the like. The control unit 5 transmits, to the lifting and lowering and rotating device 3, a control signal for controlling the lifting and lowering speed and the rotating speed of the glass fine particle deposit M. Further, the control unit 5 transmits, to the MFC 25 of the raw material supply device 21, a control signal for controlling the flow rate of the raw material gas 23 emitted from the burner 22.

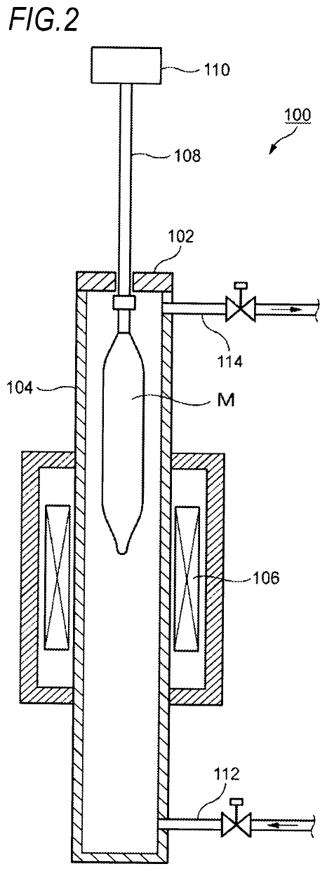

FIG. 2 is a configuration diagram of an apparatus 100 (hereinafter, also referred to as “heating and consolidating apparatus”) that performs a step of heating a glass fine particle deposit M prepared in the depositing step in an oxygen-containing atmosphere (oxidation heating step) and a transparentizing step, in a method for manufacturing a glass preform of the present embodiment.

The heating and consolidating apparatus 100 includes a furnace core pipe 104 having an upper lid 102 and a heating heater 106 disposed around the furnace core pipe 104. The heating and consolidating apparatus 100 includes a support rod 108 that holds the glass fine particle deposit Mat a lower end thereof and is to be inserted into the furnace core pipe 104, and a lifting and lowering and rotating device 110 that lowers the glass fine particle deposit M and the support rod 108 together while rotating the glass fine particle deposit M and the support rod 108 together. The heating and consolidating apparatus 100 includes a gas introduction pipe 112 for supplying an oxygen-containing gas or a He gas at a lower end of the furnace core pipe 104, and a discharge pipe 114 at an upper side of the furnace core pipe 104.

Next, the procedure of the method for manufacturing a glass preform will be described.

### [Deposition Step]

Glass particles are deposited by Outside Vapor Deposition method (OVD method) to manufacture the glass fine particle deposit M. First, as shown in FIG. 1, in a state where the support rod 10 is attached to the lifting and lowering and rotating device 3 and the starting rod 11 is attached to the lower end of the support rod 10, the starting rod 11 and a portion of the support rod 10 are placed in the furnace 2.

Then, the MFC 25 supplies the raw material gas 23 obtained by vaporizing the siloxane to the burner 22 while controlling the supply amount based on the control signal transmitted from the control unit 5.

The raw material gas 23 and the oxyhydrogen gas (flame forming gas) are supplied to the burner 22, and the raw material gas 23 is oxidized in the oxyhydrogen flame to produce glass fine particles 30.

Then, the burner 22 continuously deposits the glass fine particles 30 produced in the flame onto the starting rod 11 that is rotated and lifted and lowered.

The lifting and lowering and rotating device 3 lifts and lowers and also rotates the starting rod 11 and the glass fine particle deposit M deposited on the starting rod 11 based on the control signal transmitted from the control unit 5.

The glass raw material used in the present embodiment is not particularly limited as long as it is a siloxane, but among the siloxanes, since it is industrially easily available and can be easily stored and handled, one having a cyclic structure is preferable, and OMCTS is more preferable.

Note that, when silicon tetrachloride (SiCl₄) is used as the glass raw material instead of the siloxane, black glass fine particles are not generated, and therefore the oxidation heating step described below is unnecessary.

Although the depositing step described above has been described by taking the OVD method as an example, the present disclosure is not limited to the OVD method. The present disclosure may be applied to a method of depositing glass from a glass raw material using a flame pyrolysis reaction like the OVD method, such as a Vapor-phase Axial Deposition (VAD) method, and a Multiburner Multilayer Deposition (MMD) method, for example.

Further, for the depositing step shown above, an aspect in which the liquid glass raw material 23 is gasified and supplied to the burner 22 is specifically shown, but the liquid raw material may be supplied to the burner 22 without being gasified and ejected from the burner 22 in a liquid spray state.

### [Oxidation Heating Step]

The glass fine particle deposit M prepared in the depositing step described above is heated in an oxygen-containing atmosphere.

As shown in FIG. 2, with an upper end of the starting rod 11 being fixed to a lower portion of the support rod 108, the glass fine particle deposit M is suspended and supported by a lifting device 109 so as to be movable in a vertical direction, and is put into the heating and consolidating apparatus 100.

In this oxidation heating step, the oxygen-containing gas is supplied from the gas introduction pipe 112 of the apparatus 100 at an appropriate flow rate such that the oxygen content in the furnace core pipe 104 is appropriate.

At this time, the oxygen-containing atmosphere is preferably an atmosphere having an oxygen content of 10 vol % or more, and more preferably, an atmosphere having an oxygen content of 20 vol % or more and 100 vol % or less. A specific and preferable example of the atmosphere having an oxygen content of 10 vol % or more is an air atmosphere. Since air does not contain an unnecessarily large amount of oxygen, it does not cause explosive combustion due to heating or ignition, is easy to handle, and is advantageous in terms of cost.

The apparatus for performing the oxidation heating step may be the same as the apparatus for performing the transparentizing step to be described below, or the oxidation heating step and the transparentizing step to be described below may be performed using different apparatuses.

However, in the apparatus 100 for performing the oxidation heating step, for the material of the furnace core pipe 104, it is necessary to use a material other than carbon, such as quartz and ceramics. When the material of the furnace core pipe 104 is carbon, the furnace core pipe 104 itself is burned and damaged.

Further, when the oxygen-containing atmosphere is the air atmosphere, the apparatus 100 may not be provided with the gas introduction pipe 112 and the discharge pipe 114, and instead employ a structure in which a portion of the furnace core pipe 104 is open. However, in this case, the apparatus 100 cannot be used in the transparentizing step described below.

In the oxidation heating step, the heating temperature of the glass fine particle deposit M in the oxygen-containing atmosphere is lower than that in the transparentizing step described below, and is not particularly limited as long as the heating temperature is a temperature at which oxidation of the black glass fine particles is achieved. Specifically, the temperature is preferably 500° C. or higher and 1100° C. or lower, more preferably 600° C. or higher and 1100° C. or lower, and further more preferably 700° C. or higher and 1100° C. or lower.

The heating time in the oxidation heating step is in the range of 1 hour or longer and 8 hours or shorter in order to achieve the oxidation of the black glass fine particles. The heating time needs to be appropriately set within the above range according to the heating temperature and sizes of the glass fine particle deposit M and the furnace core pipe 104.

Generally, when the heating temperature is high, the heating time can be shortened, and when the heating temperature is low, the heating time needs to be lengthened. Further, when the sizes of the glass fine particle deposit M and the furnace core pipe 104 are large, it is necessary to raise the temperature or lengthen the time, and when the size are small, the temperature can be lowered or the time can be shortened.

When the temperature is within the range described above, the heating time is specifically in the range of 1 hour or longer and 8 hours or shorter, preferably in the range of 2 hours or longer and 7 hours or shorter, and more preferably in the range of 3 hours or longer and 6 hours or shorter. When the heating time is longer than 8 hours, the manufacturing time is too long and the productivity is reduced. Further, when the heating time is shorter than 1 hour, oxidation is not sufficient.

In this oxidation heating step, the glass fine particle deposit M may be moved in the vertical direction to pass through a heating section (e.g., in the vicinity of the heating heater 106) so as to be heated, or the glass fine particle deposit M may be heated in a stopped state.

### [Transparentizing Step]

The glass fine particle deposit M heated and oxidized in the oxidation heating step is heated at a higher temperature such that the deposit is made transparent by dehydration and consolidation.

Similar to the oxidation heating step described above, as shown in FIG. 2, with the upper end of the starting rod 11 being fixed to the lower portion of the support rod 108, the glass fine particle deposit M is suspended and supported by a lifting device 109 so as to be movable in the vertical direction, and is put into the apparatus 100.

When the same apparatus as that for performing the oxidation heating step described above is used as the apparatus for performing the transparentizing step, after completion of the oxidation heating step, the process proceeds directly to the transparentizing step.

In the apparatus 100, for example, a mixed gas of chlorine gas (Cl₂) and helium gas (He) is introduced into the furnace core pipe 104 from the gas introduction pipe 112. The temperature inside the furnace core pipe 104 is maintained in a temperature range of, for example, 1000° C. or higher and 1350° C. or lower (preferably 1100° C. or higher and 1250° C. or lower), and the glass fine particle deposit M is moved downward at a predetermined speed. When the glass fine particle deposit M reaches the final lower end position, the dehydration process ends.

Then, the glass fine particle deposit M is pulled upward and returned to the start position. While increasing the temperature in the furnace core pipe to, for example, 1400° C. or higher and 1600° C. or lower, the chlorine gas (Cl₂) and helium gas (He) in a specific ratio or only helium gas (He), for example, is concurrently introduced from the gas introduction pipe 112. The glass fine particle deposit M is again moved downward at a predetermined speed, and when it reaches the final lower end position, the transparentization of the glass is completed and the glass preform is obtained.

### [Effect]

According to the method of the embodiment described above, even when black glass fine particles are generated in the glass fine particle deposit M prepared in the depositing step, the glass fine particle deposit M is whitened by the oxidation heating step. It is assumed that this is because the black glass fine particles were completely oxidized by the oxidation heating step. Accordingly, it is assumed that the amount of voids generated in the glass preform obtained in the transparentizing step performed thereafter can be reduced.

### EXAMPLES

Hereinafter, the results of evaluation tests using examples according to the present disclosure and comparative examples will be shown, and the present disclosure will be described in more detail. Note that the present disclosure is not limited to these examples.

Glass fine particles were deposited, that is, the glass fine particle deposit M was manufactured by the OVD method using the manufacturing apparatus 1 shown in FIG. 1

### [Depositing Step].

Pure quartz glass was used as the starting rod 11. The starting rod 11 and the burner 22 for producing glass fine particles were disposed in the furnace 2, and OMCTS in a gaseous state was introduced into the burner 22 as a glass raw material. The OMCTS was oxidized in the flame formed by the burner 22 to generate the glass fine particles 30, and the produced glass fine particles 30 were deposited on the starting rod 11 to prepare a glass fine particle deposit M. As a result of measuring the surface of the obtained glass fine particle deposit M by SCI method with spectrocolorimeter and observing the color difference ΔE*ab based on white, it was blackened to 6.0.

Next, using the apparatus 100 shown in FIG. 2, the obtained glass fine particle deposit M was heated in an oxygen-containing atmosphere (air atmosphere) at a temperature lower than that in the transparentizing step performed thereafter [Oxidation heating step].

The prepared glass fine particle deposit M is attached to the apparatus 100, and while supplying air at a flow rate of 10 slm from the gas introduction pipe 112, the inside of the furnace core pipe 104 was heated by the heating heater 106 to a predetermined temperature, and the heating was continued for 1 hour.

Here, for the glass fine particle deposits M, six specimens were prepared under the same condition and each was attached to one apparatus 100, and in each apparatus 100, the temperature in the furnace core pipe 104 was heated to 500° C., 600° C., 700° C., 800° C., and 900° C., respectively. Note that one of the six specimens was not subjected to oxidation heating. The surface of the glass fine particle deposit M after being heated and oxidized at each temperature was measured by the SCI method with the spectrocolorimeter and the color difference ΔE*ab based on white was observed. The results are shown in Table 1 below.

Further, in the same apparatus, after being heated to 1100° C. in a mixed atmosphere of He gas and chlorine gas, transparent glass was made by being heated to 1550° C. in a He atmosphere [Transparentizing step].

Specifically, after heating in the air atmosphere described above, He gas and chlorine gas were introduced from the gas introduction pipe 112 of the apparatus 100, and after being heated to 1100° C., while supplying He gas from the gas introduction pipe 112 of the apparatus 100, the furnace core pipe 104 was heated with the heating heater 106 so that the inner temperature thereof was 1550° C., thereby achieving transparentization.

The glass preform manufactured by the operation described above was evaluated for the presence or absence of voids, and the results are shown in Table 1 below.

In the evaluation of voids, halogen lamp light was irradiated from the side surface of the glass preform, the inside of the glass preform was visually observed, the number of voids having a size of 1 mm or more was measured, the evaluation was performed by the number of voids contained in the glass preform per 100 km of the converted length when drawn.

In Table 1 below, Nos. 1 to 5 are the results of examples, and No. 6 is the result of the comparative Example.

TABLE 1

| | Heating | ΔE*ab of surface | Amount of |
|---|---|---|---|
| | temperature | of glass fine | voids generated |
| | in oxidation | particle deposit | in glass preform |
| | heating step | M after oxidation | (number/100 km |
| No. | (° C.) | heating step | converted length) |
| 1 | 500 | 4.1 | 4.3 |
| 2 | 600 | 3.4 | 3.1 |
| 3 | 700 | 2.1 | 1.8 |
| 4 | 800 | 1.2 | 1.2 |
| 5 | 900 | 0.5 | 0.5 |
| 6 | No heating | 6.0 | 31 |

From Nos. 1 to 5 in Table 1 described above, as the heating temperature in the oxidation heating step was increased, the ΔE*ab value of the surface of the glass fine particle deposit M after the oxidation heating step was reduced, and the amount of voids generated in the obtained glass preform was also reduced. On the other hand, with respect to No. 6 in which the oxidation heating step was not performed, the ΔE*ab value of the surface of the glass fine particle deposit M was large, and many voids were generated in the glass preform.

### REFERENCE SIGNS LIST

1: deposit manufacturing apparatus
2: furnace
3: lifting and lowering and rotating device
5: control unit
10: support rod
11: starting rod
12: discharge pipe
21: raw material supply device
22: burner
23: raw material gas
23A: liquid raw material
24: vaporization container
25: MFC
26: supply pipe
27: temperature control booth
28: tape heater
30: glass fine particles
100: heating and consolidating apparatus
102: top lid
104: furnace core pipe
106: heating heater
108: support rod
110: lifting and lowering and rotating device
112: gas introduction pipe
114: discharge pipe
M: glass fine particle deposit

1. A method for manufacturing a glass preform, the method comprising:
preparing a glass fine particle deposit by installing a starting rod and a burner for producing glass fine particles in a furnace, introducing a siloxane as a glass raw material to the burner, producing the glass fine particles by oxidizing the glass raw material in a flame formed by the burner, and depositing the produced glass fine particles on the starting rod; and
manufacturing a transparent glass preform by heating the glass fine particle deposit,
wherein, after the preparing of the glass fine particle deposit is performed, the glass fine particle deposit is heated in a range of 1 hour or longer and 8 hours or shorter in an oxygen-containing atmosphere at a temperature lower than a temperature at which the manufacturing of the transparent glass preform is performed, and then, the manufacturing of the transparent glass preform is performed.

2. The method for manufacturing a glass preform according to claim 1,
wherein a heating temperature in the oxygen-containing atmosphere is in a range of 500° C. or higher and 1100° C. or lower.

3. The method for manufacturing a glass preform according to claim 1,
wherein an oxygen content in the oxygen-containing atmosphere is 10 vol % or more.

4. The method for manufacturing a glass preform according to claim 1,
wherein the oxygen content in the oxygen-containing atmosphere is in a range of 20% vol % or more and 100 vol % or less.

5. The method for manufacturing a glass preform according to claim 4,
wherein the oxygen-containing atmosphere is an air atmosphere.
